(19) United States
(12) Patent Application Publication
(10) Pub. No.: US 2011/0232069 A1
(43) Pub. Date: Sep. 29, 2011

(54) AUTOMATIC RIVET DIE

(76) Inventor: Lovro Gotovac, Woodbridge (CA)

(21) Appl. No.: 12/732,703

(22) Filed: Mar. 26, 2010

(51) Int. Cl. B21D 39/00; B23P 11/00

(52) U.S. Cl. 29/524.1; 29/243.53

(57) ABSTRACT

A device to rivet two pieces together each having aligned holes comprising a rivet holder body having a cylindrical hole there through, an upper punch and a lower punch coaxially disposed along an axis of a cylindrical hole presented in the rivet holder body; structure for guiding a rivet to the rivet holder body in a selected orientation as well as structure for catching the falling rivet in the cylindrical hole when the upper and lower punches are in a first separated position and to withdraw from the cylindrical hole as the upper punch moves relative to the lower punch to a second riveting position.

### FIELD OF INVENTION

This invention relates to a device or tool to rivet two pieces together and the method relating thereto. The invention also relates to an automatic rivet die to rivet two pieces together each having a plurality of aligned holes which includes slideable pins to catch the rivets when an upper and lower punch are in a separated position and to release the rivets when the upper punch moves relative to the lower punch so as to rivet the pieces together.

### BACKGROUND TO THE INVENTION

There are many applications where two pieces need to be fastened together. Such pieces may take on any number of configurations and orientations. One such application includes the riveting of two flat pieces together such as sheet or plate metal or the like. Generally speaking the pieces that need to be riveted will have holes in each piece that need to be aligned for the rivet to pass there through. It is not unusual where such two pieces will include a plurality of holes that align with one another where each set of aligned holes are adapted to receive a rivet there through for riveting purposes.

Currently the prior art requires an operator to align the two pieces together so that the holes in each of the parts are aligned and manually insert rivets either in a punch assembly or die. Accordingly the cycle time to manually align and insert the rivets in the aligned holes of the two pieces is huge; and this operation has become a bottleneck in production.

Accordingly there is a need for an automatic rivet feeding mechanism which is less labour intensive and where the cycle time between punching between an upper and lower die is improved.

Various devices and methods have heretofore been used by the prior art including the automated sidewall assembly machine disclosed in U.S. Pat. No. 7,610,668.

Another device is shown in U.S. Pat. No. 6,161,273 which relates to a method and apparatus performing rivet joints. This patent discloses a method and apparatus performing rivet joints that allow pivotal motion of the parts interconnected by such joints with the desired amount of clearance.

Another arrangement is disclosed in U.S. Pat. No. 5,774,968 which relates to an electromagnetic riveter recoil cushioning dampening and positioning system. U.S. Pat. No. 4,404,742 illustrates a method and apparatus for mounting rivets or the like in a flexible carrier.

Another arrangement is shown in U.S. Pat. No. 4,133,096 which relates to an apparatus and method for self-positioning a squeezed rivet.

Finally U.S. Pat. No. 5,476,204 teaches an automated stud setting apparatus.

It is an object of this invention to provide an improved automated riveting die which is easier to use.

It is an aspect of this invention to provide a device or tool to rivet two pieces together each having aligned holes comprising: a rivet holder body having a cylindrical hole thereto presenting an axis; an upper punch and a lower punch coaxially disposed along the axis of the cylindrical hole and moveable relative each other from a first separated position to a second riveting position with the aligned holes of the two pieces coaxially disposed between the upper and lower punches; structure for guiding a rivet to the rivet holder body in a selected orientation so as to fall through the cylindrical hole when the first and second punches are in the first separated position; structure for catching the falling rivet in the cylindrical hole and to withdraw from the cylindrical hole as the upper punch moves relative to the lower punch to the second riveting position so as to rivet the two pieces together.

It is another aspect of this invention to provide an automatic rivet die to rivet two pieces together each having a plurality of aligned holes comprising: a plurality of rivet holder bodies each having a cylindrical hole there through, each plurality of rivet holder bodies presenting an axis disposed parallel to one another; each rivet holder body having a cylindrical hole there through presenting an axis disposed parallel to one another; each rivet holder body having an upper punch and a lower punch coaxially disposed along the axis of the cylindrical hole and moveable relative each other from a first separated position to a second riveting position where each of the aligned holes of the plurality of aligned holes of the two pieces are coaxially disposed between one of the upper and lower punches respectively; a plurality of flexible tubes for the plurality of rivet holder bodies respectively for guiding a plurality of rivets respectively to each of the rivet holder bodies in a selected orientation so as to fall through the cylindrical holes of each of the rivet holder bodies when the plurality of first and second punches are each in the first separated position; three pins for each rivet holder body and slideable relative the rivet holder body, where each of the three pins are disposed generally perpendicular and equidistant about the axis of each of the rivet holder bodies where an end of each of the pins catches the falling rivet in the cylindrical hole when the upper and lower punches are in the first separated position and where the end of each of the pins moves away from the rivet as the upper punches move relative to the lower punches to the second riveting position and rivet the two pieces together.

It is a further aspect of this invention to provide a method of automatically aligning and riveting two pieces together each having holes there through comprising: feeding a rivet along a path in a selected orientation into a rivet holder body having a cylindrical hole there through presenting an axis so as to fall there through; moving an upper punch relative to a lower punch coaxially within the cylindrical hole along the axis from a first separated position to a second riveting position; catching the falling rivet in the cylindrical hole when the upper punch and lower punch are in the first separated position; releasing the rivet when the upper punch and lower punch move relative to one another to rivet the two pieces together.

These and other objects and features of the invention shall now be described in relation to the following drawings.

### DRAWINGS

FIG. 1 is an exploded view of the invention to be described herein.

FIG. 2 is a perspective and partial cross sectional view of the invention shown in FIG. 1.

FIG. 3 is a cross sectional side elevational view of the invention to be described herein.

FIG. 4 is a bottom view of FIG. 3.

FIG. 5 shows the two parts riveted together.

### DETAILED DESCRIPTION OF THE INVENTION

Like parts are numbered with like numbers throughout the figures. Furthermore the drawings may not necessarily be to scale.

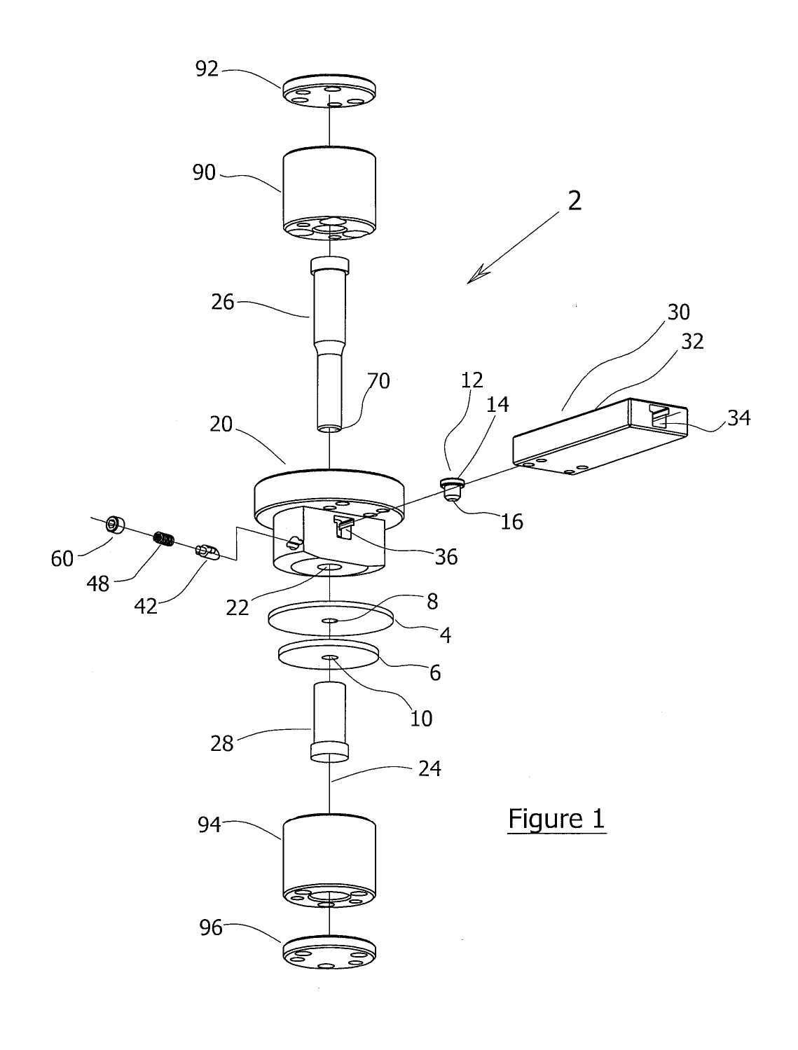

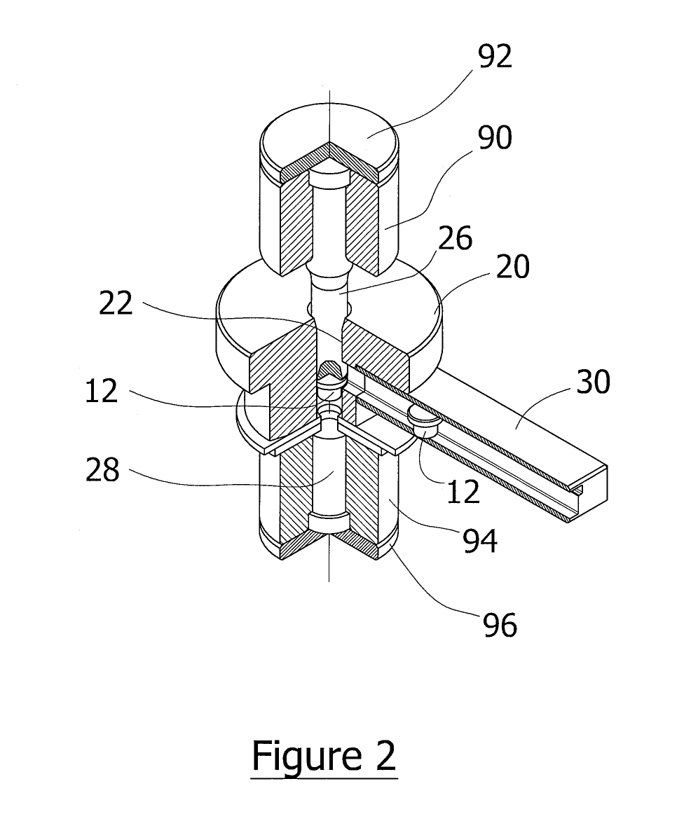

FIG. 1 illustrates a device, tool or automatic riveting die 2 to rivet two pieces 4 and 6 together. Each of the pieces 4 and 6 include holes 8 and 10 respectively which are aligned so as to be riveted or fastened together by a rivet 12. The rivet can have any number of configurations and in the embodiment shown includes a head 14 and a chamfered end 16. The rivet is comprised of any common material such as soft metal or the like. Furthermore a gig can be used to align the holes 8 and 10 in a manner well known to people skilled in the art. Moreover the invention to be described herein can be used to fasten or rivet a plurality of holes 8 and 10 in the parts 4 and 6.

The device 2 comprises a rivet holder body 20 having a cylindrical hole 22 there through. The cylindrical hole 22 presents an axis 24.

The device 2 also includes an upper punch 26 and a lower punch 28 coaxially disposed along the axis 24 of the cylindrical hole 22. The upper punch 26 is moveable relative to the lower punch 28 from a first separated position to a second riveting position where the aligned holes 8 and 10 of the parts 4 and 6 are coaxially disposed between the upper and lower punches 26 and 28 as shown.

The automatic rivet die 2 also includes means 30 for guiding a rivet 12 to the rivet holder body 20 in a selected orientation so as to fall through the cylindrical hole 22 when the first and second punches 26 and 28 are in the first separated position. In the embodiment as shown in FIG. 1 the means for catching 30 the falling rivet 12 comprises flexible tubing 32 which has a cross section 34 which is similar to the profile of the rivet 12. The rivet 12 is moved through the flexible tubing 32 by means of air pressure so as to move through the flexible 32 to the inlet 36 of the rivet holder body 20. The inlet 32 is aligned with the flexible tubing 30, and has a similar cross section to the profile of the rivet 12. The inlet 36 intersects or communicates with the cylindrical passage 22 so that when the rivet moves through the flexible tubing into the inlet 36 the rivet will then fall by gravity downwardly as shown in FIG. 1.

The automatic rivet die 2 also includes means 40 for catching the falling rivet 12 in the cylindrical hole 22 when the upper punch 26 is in a first separated position. The means for catching 40 also withdraw from the cylindrical hole 22 as the upper punch 26 moves relative to the lower punch 28 to the second riveting position so as to rivet the two pieces 4 and 6 together as shown in FIG. 5.

The catch means 40 comprise at least one pin 42 disposed for slideable movement relative to the rivet holder body 20 so as to catch the falling rivet 12 when the upper and lower punches 26 and 28 are in the first separated position and withdraw from the cylindrical hole 22 as the upper punch moves relative to the lower punch to the second riveting position.

The catch means 40 include bores 44 in the rivet holder body 22. The bores 44 each have an axis 46 which is disposed generally equidistant around the axis 24 and are generally disposed perpendicular thereto.

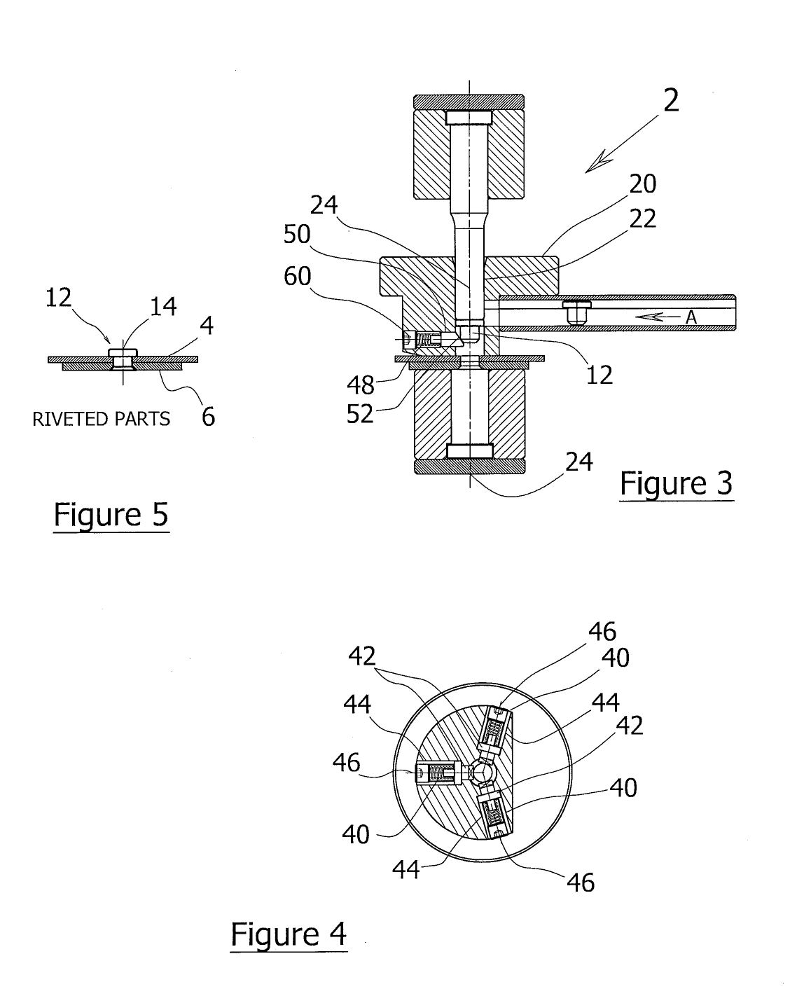

Each of the bores 44 include a spring 48 which is engageable with one end 50 of the pin 42. The other end 52 of the pin 42 is adapted to catch the rivet 12 as best seen in FIG. 3. The other end 52 of the pin can be angled as shown in FIG. 3 so as to engage the chamfered end 16 of the rivet 12. With the three pins as shown in FIG. 4 the rivet 12 is caught and orientated in an upright position so as to minimize the misfeeding of a rivet during a press cycle which would otherwise result in a disastrous situation. In other words the rivet is oriented so that it is coatial with the axis 24, and upper punch 26 and lower punch 28.

The pin 42 can have one end 50 which is smaller in diameter so as to fit within the spring 48 with the larger diameter other end 52 as shown. A set screw 60 can be tapped into the rivet body holder as shown so as to adjust the tension of the spring. The spring 48 biases the other end 52 of the pins 42 so as to catch the falling rivet 12 as previously described. As the upper punch 26 moves relative to the lower punch 28 the one end of the punch 70 contacts the head 14 of the rivet 12 so as to move downwardly as shown in FIG. 3 and at the same time pushing against the other end 52 of the pins 42 causing the springs 48 to contract and moving or withdrawing the pins so as to allow the rivet 12 to slide into the aligned holes 8 and 9 of parts 4 and 6. The lower punch 28 has mounted thereon the parts 4 and 6. Accordingly as the punch continues to move down into the riveting position the rivet 12 is deformed so as to produce a riveted part as shown in FIG. 5. The chamfered end 16 of the rivet 12 bears against the upper punch 28 and is deformed there between.

The punch 26 moves relative the lower punch 28. Accordingly, lower punch 28 could be stationary, or could also move, relative the upper punch 26.

The invention as described herein can be used to fasten at least two pieces 4 and 6 together which can have a plurality of aligned holes 8 and 9. In this event a plurality of rivet holder bodies 20 would be used each of which would have an upper and lower punch 26 and 28 as previously described.

Accordingly the invention as described herein also relates to an automatic rivet die 2 to rivet two pieces 4 and 6 together, each piece 4 and 6 having a plurality of aligned holes 8 and 10 comprising a plurality of rivet holder bodies 20, each having a cylindrical hole 22 there through, each presenting an axis 24 disposed parallel to one another; for each of the aligned holes 8 and 10. Each of the rivet holder bodies 20 have an upper punch 26 and a lower punch 28 coaxially disposed along the axis 24 of the cylindrical hole 22 and moveable relative each other from a first separated position to a second riveting position where each of the plurality of aligned holes of the two pieces are coaxially disposed between one of the upper and lower punches respectively. Furthermore a plurality of flexible tubing 30 is presented for each of the plurality of rivet holder bodies 20 respectively for guiding a plurality of rivets 12 respectively to the rivet holder bodies 20 in a selected orientation so as to fall through the cylindrical holes 22 when the plurality of first and second punches for each of the plurality of rivet holder bodies 20 are in the first separated position. Furthermore three pins 42 slidingly move relative each of the rivet holder bodies 20 and are each disposed generally perpendicular and equidistant about the axis 24 of each of the rivet holder bodies 20 where an end 50 of each of the pins 42 catches the falling rivet 12 in the cylindrical hole 22 and where the upper and lower punches 26 and 28 are in the first separated position and where another end 52 of each of the pins 42 moves away from the rivet 12 as the upper punch 26 moves relative to the lower punch 28 to the second riveting positions and rivet the pieces together. In other words the pieces shown in FIG. 3 would have a plurality of aligned holes 8 and 10 and there would be a plurality of devices 2 for each set of aligned holes 8 and 10.

The invention described herein also relates to a method of automatically aligning and riveting two pieces together each having holes there through including the steps of:
(a) feeding a rivet 12 along a path in a selected orientation into a rivet holder die 20 having a cylindrical hole there through presenting an axis 24;
(b) relatively moving an upper punch 26 relative a lower punch 28 coaxially within a hole 22 along the axis 24 from a first separated position to a second riveting position;
(c) catching the falling rivet 12 in the cylindrical hole 22 when the upper punch 26 and lower punch 28 are in the first separated position; and
(d) releasing the rivet 12 when the upper punch 26 and lower punch 28 move relative to one another so as to rivet the pieces together.

As shown one of the pieces 6 has a chamfered end to receive the deformed rivet 12 when the punches 26 and 28 squeeze the rivet. Moreover the method shows that a rivet is fed along a path in a first direction A and the axis 24 of the cylindrical hole 22 is in a second direction. Furthermore the first and second directions A and 24 are perpendicular to one another.

Also the die 2 also includes an upper punch holder 90, upper backup plate 92, and a lower punch holder 94 and lower backup plate 96.

We claim:

1. A device to rivet two pieces together each having aligned holes comprising:
(a) a rivet holder body having a cylindrical hole there through presenting an axis;
(b) an upper punch and a lower punch coaxially disposed along the axis of the cylindrical hole and moveable relative each other from a first separated position to a second riveting position with the aligned holes of the two pieces coaxially disposed between the upper and lower punches;
(c) means for guiding a rivet to the rivet holder body in a selected orientation so as to fall through the cylindrical hole when the first and second punches are in the first separated position;
(d) means for catching the falling rivet in the cylindrical hole when the upper and lower punches are in the first separated position and to withdraw from the cylindrical hole as the upper punch moves relative to the lower punch to the second riveting position so as to rivet the two pieces together.

2. A device as claimed in claim 1 wherein said guiding means comprises flexible tubing having a cross section similar to the profile of the rivet.

3. A device as claimed in claim 2 where the rivet is pushed through the flexible tubing by air pressure.

4. A device as claimed in claim 3 wherein the rivet holder body has an inlet communicating with the flexible tubing and communicates with the cylindrical hole so that the rivet falls through the cylindrical hole by gravity.

5. A device as claimed in claim 4 wherein the catching means comprises at least one pin disposed for slideable movement relative the rivet holder body so as to catch the falling rivet when the upper and lower punches are in the first separated position and withdraw from the cylindrical hole as the upper punch moves relative to the lower punch to the second riveting position.

6. A device as claimed in claim 5 wherein the catch means comprises bores in the rivet holder body for each of the pins.

7. A device as claimed in claim 6 wherein the catch means includes springs in each bore engageable with one end of the pins.

8. A device as claimed in claim 7 wherein the catch means comprises three pins disposed equally about the axis.

9. A device as claimed in claim 8 wherein each spring is engageable with one end of the pins so as to bias the other end of the pin into the cylindrical hole to catch the falling rivet; the springs each contracting as the upper punch moves relative to the lower punch to rivet the two pieces together.

10. An automatic rivet die to rivet two pieces together each having a plurality of aligned holes comprising:
(a) a plurality of rivet holder bodies each having a cylindrical hole there through each plurality of rivet holder bodies presenting an axis disposed parallel to one another;
(b) each rivet holder body having a cylindrical hole there through presenting an axis disposed parallel to one another;
(c) each rivet holder body having an upper punch and a lower punch coaxially disposed along the axis of the cylindrical hole and moveable relative each other from a first separated position to a second riveting position where each of the aligned holes of the plurality of aligned holes of the two pieces are coaxially disposed between one of the upper and lower punches respectively; a plurality of flexible tubes for the plurality of rivet holder bodies respectively for guiding a plurality of rivets respectively to each of the rivet holder bodies in a selected orientation so as to fall through the cylindrical holes of each of the rivet holder bodies when the plurality of first and second punches are each in the first separated position;
(d) three pins for each rivet holder body and slideable relative the rivet holder body, where each of the three pins are disposed generally perpendicular and equidistant about the axis of each of the rivet holder bodies where an end of each of the pins catches the falling rivet in the cylindrical hole when the upper and lower punches are in the first separated position and where the end of each of the pins moves away from the rivet as the upper punches move relative to the lower punches to the second riveting positions and rivet the two pieces together.

11. A method of automatically aligning and riveting two pieces together each having holes there through comprising:
(a) feeding a rivet along a path in a selected orientation into a rivet holder body having a cylindrical hole there through presenting an axis so as to fall there through;
(b) moving an upper punch relative to a lower punch coaxially within the cylindrical hole along the axis from a first separated position to a second riveting position;
(c) catching the falling rivet in the cylindrical hole when the upper punch and lower punch are in the first separated position;
(d) releasing the rivet when the upper punch and lower punch move relative to one another to rivet the two pieces together.

12. A method as claimed in claim 11 wherein one of the pieces has a chamfered hole to receive the deformed rivet.

13. A method as claimed in claim 12 wherein the rivet is fed along a flexible path having a similar cross section to the profile of the rivet.

14. A method as claimed in claim 13 wherein the rivet is caught by pins slideable relative to the rivet holder body.

15. A method as claimed in claim 14 wherein the two pieces have a plurality of holes to be aligned and riveted and the method includes a plurality of upper and lower punches respectively for each of the aligned holes.

16. A method as claimed in claim 15 wherein the rivet is fed along a path in a first direction and the axis of the cylindrical hole is in a second direction.

17. A method as claimed in claim 16 wherein the first and second directions are perpendicular to one another.

18. A method as claimed in claim 17 wherein the rivet has a chamfered end.

19. A method as claimed in claim 18 wherein the chamfer end is caught by the pins.

20. A method as claimed in claim 19 wherein the pins have an angled end to catch the chamfered end of the rivet.
